(19) United States
(12) Patent Application Publication
(10) Pub. No.: US 2008/0270017 A1
(43) Pub. Date: Oct. 30, 2008

(54) Asynchronous inertial navigation system

(76) Inventor: Steven L. Saks, Woodland Hills, CA (US)

Correspondence Address: Carole A. Mulchinski, M1/040;The Aerospace Corporation,, 2350 East El Segundo Boulevard, El Segundo, CA, 90245, US

(21) Appl. No.: 11/789,962

(22) Filed: Apr. 26, 2007

(51) Int. Cl. G01C 21/10; G04B 47/00

(52) U.S. Cl. 701/200

(57) ABSTRACT

A asynchronous inertial navigation system uses two asynchronous clocks, a first clock for an inertial measurement unit and a second clock for an inertial navigation processor, where the inertial measurement unit communicates asynchronously rate data samples to the inertial navigation processor that measures the time separation of the received rate data samples for computing a navigation solution using an asynchronously attached inertial measurement unit.

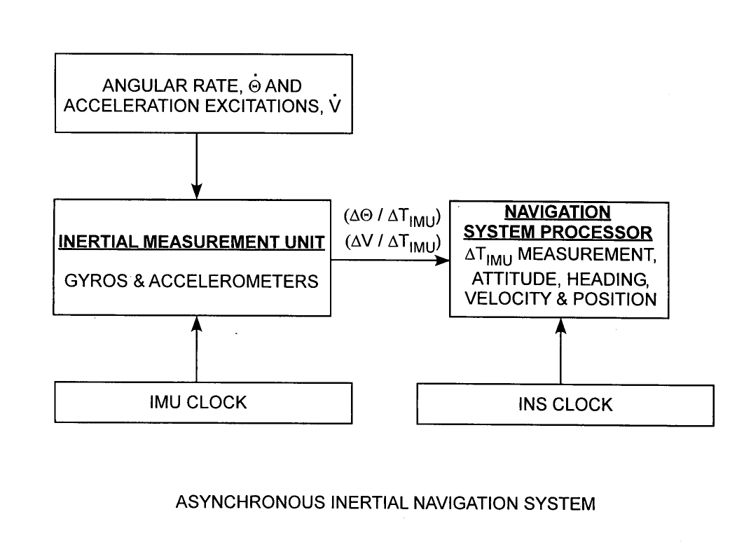

### STATEMENT OF GOVERNMENT INTEREST

The invention was made with Government support under contract No. FA8802-04-C-0001 by the Department of the Air Force. The Government has certain rights in the invention.

### FIELD OF THE INVENTION

The invention relates to the field of synchronized systems. More particularly, the present invention relates to sampling and monitoring system having synchronized communications of time-sensitive sampled data.

### BACKGROUND OF THE INVENTION

Synchronous systems using a common clock have long been used to synchronously communicate sample data between at least two synchronized subsystems. There are many examples of such system.

A power consumption metering system is used for computing total energy consumption, usually in Kilo-watt-hours. The power consumption metering system consists of two subsystems synchronously operating using a reference clock. The two subsystems include a measurement unit and a processor unit. The measurement unit samples the amount of energy over unit time, that is, power. The measurement unit and the processing unit operate using a signal synchronizing clock to cyclically measure energy per unit time, which is power, and sends the measurements to a processor unit. The processor unit receives the power readings in samples that are communicated synchronously from the measurement unit to the processor unit at time between arrivals referenced in time to the synchronous clock. The processor unit then computes the total energy value from the samples over predetermined synchronous clock periods.

A water consumption metering system is used for computing total water consumption in acre-feet volume. The water consumption metering system consists of two subsystems synchronously operating using a reference clock. The two subsystems include a measurement unit and a processor unit. The measurement unit cyclically measures water flow rates in acre-feet per unit time and sends the measurements to a processor synchronously operating to the same clock. The processor unit then computes the total water volume from the samples over predetermined synchronous clock periods.

An inertial navigation system is used for determining navigation solutions. The inertial navigation system consists of two subsystems. The two subsystems include an inertial measurement unit and an inertial navigation processor unit. The inertial measurement unit normally includes gyros and accelerometers for providing binary sample data. The inertial measurement unit synchronously provides linear acceleration and angular rate data samples to the processor unit. The navigation solution includes attitude, heading, velocity, and position data. The processor unit computes the navigation solution from the data samples provided over predetermined synchronous clock periods.

There are many examples of synchronous systems having two synchronous subsystems, including a measurement unit and a processor unit, where the data samples from the measurement unit are rate or time derivative sampled data provided at precise time intervals. The samples are precisely sampled in time and precisely synchronously communicated with reference clock used by both the measurement unit and the processor unit. The synchronous communications effectively provide for time stamped the sampled data. The system disadvantageously requires precise synchronous communications as two separate clocks cannot be used due to frequency drift reducing the accuracy of the computed results. These synchronous systems disadvantageously require that both subsystems use the same precise reference clock and require that the samples be provided at known time stamped intervals so that the processor unit can integrate the time derivative sampled data to determine the intended integrated results that are time oriented. These and other disadvantages are solved or reduced using the invention.

### SUMMARY OF THE INVENTION

An object of the invention is to provide asynchronous communication of data samples from a measurement unit to a processor unit.

Another object of the invention is to provide asynchronous communications of data samples from a measurement unit to a processor unit where the measurement unit provides the data samples asynchronously to the processor unit.

Yet another object of the invention is to provide asynchronous communications of data samples from a measurement unit to a processor unit where the measurement unit provides the data samples asynchronously to the processor unit, where the measurement unit communicates the data samples synchronously using a measurement unit clock while the processor unit determines a result from the data samples using a processor clock.

Yet a further object of the invention is to provide asynchronous communications of time derivative data samples from a measurement unit to a processor unit where the measurement unit provides the data samples asynchronously to the processor unit, where the measurement unit communicates the data samples synchronously with a measurement unit clock while the processor unit determines a result from the data samples using a processor clock.

Still a further object of the invention is to provide asynchronous communications of rate measurement data samples from a measurement unit to a processor unit where the measurement unit provides the rate measurement data samples asynchronously to the processor unit, where the measurement unit communicates the data samples synchronously with a measurement unit clock while the processor unit determines a result from the data samples using a processor clock.

Still another object of the invention is to provide asynchronous communications of velocity rate and angular rate measurements from an inertial measurement unit to a navigation processor unit, where the measurement unit provides the velocity rate and angular rate measurements asynchronously to the processor unit, where the measurement unit communicates the rate measurements synchronously with a measurement unit clock while the processor unit determines a result from the rate measurements using a processor clock.

The invention is directed to a system for asynchronously communicating measurement data time derivative data samples from a measurement subsystem to a processor subsystem. The measurements are data samples that are preferably rate measurements. The two subsystems use two separate and asynchronous reference clocks. In the preferred form, a navigation system includes an inertial measurement unit and a navigation processor unit. The inertial measurement unit asynchronously provides linear acceleration and heading, pitch, and roll angular rate data samples to the processing unit. The processing unit receives the rate data samples at irregular intervals with respect to a processor clock. The processing unit determines the time intervals between successive data samples for determining an integrated value of the data samples. The processor unit can use asynchronously communicated rate data samples for accurately computing the navigation solution. These and other advantages will become more apparent from the following detailed description of the preferred embodiment.

### BRIEF DESCRIPTION OF THE DRAWINGS

The drawing is a block diagram of an asynchronous inertial navigation system.

### DETAILED DESCRIPTION OF THE PREFERRED EMBODIMENT

An embodiment of the invention is described with reference to the FIGURE using reference designations as shown in the FIGURE. An asynchronous inertial navigation system includes an inertial measure unit (IMU) that is driven by an IMU clock and includes an inertial navigation system (INS) processor that is driven by an INS clock. The IMU clock and the INS clock run asynchronously. That is, the IMU clock drifts in timing with respect to the INS clock. The IMU typically includes gyros and accelerometers that are excited by \dot{θ}, angular rate and \dot{V}, acceleration rate excitations. The IMU provides quantized rate data samples Δθ_{IMU}/ΔT_{IMU} and ΔV_{IMU}/ΔT_{IMU} at a fixed rate that is 1/ΔT_{IMU}. The processor unit is programmed to measure the ΔT_{IMU} from successive data samples. The ΔVs/ΔT_{IMU} rate data samples and Δθs/ΔT_{IMU} rate data samples are integrated in an INS processor by determining the ΔT between successive rate samples. The computed ΔT is a time base for integrating the rate sample values over the ΔT time for integrating the rate data into an integrated result. The integrated result can be for example velocity data from acceleration data where the acceleration data is a rate data over the ΔT time period.

The asynchronous IMU communication defines a functional data node resident in all strapdown INS. The design is independent of gyro or accelerometer sensor technology and contains sufficient interface bandwidth to be suitable for various applications. The asynchronous system can be applied to any known moving craft for determining navigation solutions. The invention has an unprecedented advantage of being asynchronous and therefore, allows any IMU to be integrated with any receiver or INS processor regardless of receiver or processor timing schemes without any performance penalty. The IMU is not physically slaved to the INS processor clock. The IMU can be physically separated from the processor unit. The INS processor measures the ΔT_{IMU}, the IMU measurement interval, by measuring the time between arrivals of IMU data sets at the processor unit, and integrating the IMU angular and linear measurements using the measured and variable time intervals ΔTs.

The system has an asynchronous interface without a performance penalty. The asynchronous interface can be achieved using a simple RS-422 serial bus, and specifying a fixed jitter requirement on the IMU for the time uncertainty between rate data samples. The system is compatible with any existing navigation grade strapdown INS as the INS processor can be programmed to determine the time interval spacing between received IMU rate data samples.

The asynchronous system design effectively enables any IMU to be integrated with any INS processor with a simple serial RS-422 serial bus. The communication path from the IMU and the processor defines a data node that is common to all strapdown INS. As such, design accommodates any inertial sensor technology types such as fiber optic, spinning wheel, and coriolois. A robust IMU having any number of gyros and accelerometers can be used. As may now be apparent, the invention can be applied to measurement systems that provide rate data samples over a synchronized communication path where the time between samples can be used to integrate the rate data samples for determining an integrated result.

A power consumption metering system can integrate energy rate data over ΔT time interval for computing energy consumed over that time interval. The measurement unit, operating off a separate clock, cyclically measures energy per unit time. Every N cycles, the measurement unit sends the summation of N digital measurements to a processor also operating with a respective clock. The processor, asynchronously operating with the measurement unit, measures the time interval of the N measurements by measurement of the time between arrivals of power measurements using the processor clock. The processor then multiples the received digital power measurement by the time measurement to compute the kilo-watt-hours over the time interval. The processor then adds the computed interval kilo-watt-hours to an accumulated sum to computed total kilo-watt-hours power consumed.

A water consumption metering system can integrate water flow rate to compute a total water volume. The water consumption system measures flow rate as delta acre-feet over the ΔT time interval, ΔV/ΔT. The measurement unit, operating off a respective measurement clock, cyclically measures water per unit time, ΔV/ΔT and sends the digital measurements to a processor operating using a respective processor clock. The processor measures the time interval of the measurements by measurement of the time between arrivals of water flow rate measurements via the processor clock and the received digital water rate data measurement by the time measurement ΔT to compute the water volume over the time interval. The processor then adds the computed interval acre-feet to an accumulated sum for a computed total acre-feet of water volume consumed.

The present invention is directed to a system having two subsystems, each operating with respective clocks. A measurement subsystem asynchronously communicates rate data samples over time intervals. A processor subsystem receives the rate data samples, measures the time intervals, and computes an integrated result. While the system can be applied to inertial navigation systems, power systems, and water systems, the invention can be widely applied in other rate measurement applications. Those skilled in the art can make enhancements, improvements, and modifications to the invention, and these enhancements, improvements, and modifications may nonetheless fall within the spirit and scope of the following claims.

What is claimed is:

1. A system for receiving excitations and providing an integrated result, the system comprising
a first clock providing a first clock signal,
a measurement unit for receiving the excitations and for receiving the first clock, the measurement unit for providing rate measurements from the excitations, the measurement unit providing the rates measurements synchronized to the first clock, the measurements being provided recurrently and separated by time intervals, the time intervals being synchronized to the first clock,
a second clock providing a second clock signal, and
a processing unit for asynchronously receiving the rate measurements from the measurement unit, the processing unit computing the time intervals between the rate measurements, the processing unit for computing the integrated result from the measurements and the time intervals, the integrated result being computed synchronously with the second clock.

2. The system of claim 1 wherein,
the first clock is an inertial measurement clock,
the measurement unit is an inertial measurement unit,
the processor unit is an inertial navigation system processor unit,
the second clock is an inertial navigation system processor clock,
the rate measurements comprise velocity rate measurements, and
the integrated result comprises a velocity result.

3. The system of claim 1 wherein,
the first clock drifts respecting the second clock.

4. The system of claim 1 wherein,
the rate measurements are water flow rate measurements, and
the integrated result is water volume.

5. The system of claim 1 wherein,
the rate measurements are energy rate measurements, and
the integrated result is an energy result.

6. A system for receiving excitations and providing a system state, the system comprising
a first clock providing a first clock signal, a measurement unit for receiving the excitations and for receiving the first clock, the measurement unit providing the measurements synchronized to the first clock, the measurements being provided recurrently and separated by time amounts, the time amounts being synchronized to the first clock,
a second clock providing a second clock signal, and
a processing unit for asynchronously receiving the measurements from the measurement unit, the processing unit computing the time amounts between the measurements, the processing unit for computing the system state from the measurements and the time amounts, the system state being computed synchronously with the second clock.

7. The system of claim 6 wherein,
the first clock drifts respecting the second clock.

8. An inertial navigation system for receiving rate excitations and providing a navigation solution, the system comprising
an inertial measurement unit clock providing an inertial measurement unit clock signal,
an inertial measurement unit for receiving the rate excitations and for receiving the inertial measurement unit clock, the measurement unit providing rate measurements synchronized to the inertial measurement unit clock, the rate measurements being provided recurrently and separated by time intervals, the time intervals being synchronized to the inertial measurement unit clock,
an inertial navigation processor clock providing an inertial navigation system clock signal, and
a inertial navigation processing unit for asynchronously receiving the rate measurements from the inertial measurement unit, the inertial navigation processing unit computing the time intervals between the rate measurements, the inertial navigation processing unit for computing the navigation solution from the rate measurements and the time intervals, the navigation solution being computed synchronously with the inertial navigation system clock signal.

9. The inertial navigation system of claim 8 wherein,
the rate excitations include velocity rate excitations and angular rate excitations.

10. The inertial navigation system of claim 8 wherein,
the rate excitations include velocity rate excitations and angular rate excitations, and
the angular rate excitations comprise yaw, pitch, and roll rate excitations.

11. The inertial navigation system of claim 8 wherein,
the rate excitations are velocity rate excitations,
the velocity rate excitations are linear acceleration excitations.

12. The inertial navigation system of claim 8 wherein,
the inertial measurement unit clock drifts respecting the inertial navigation processor clock.
